(19) United States
(12) Patent Application Publication
(10) Pub. No.: US 2014/0108126 A1
(43) Pub. Date: Apr. 17, 2014

(54) DIGITAL MEDIA INDEX

(71) Applicant: Telemetry Limited, London (GB)

(72) Inventors: Geo CARNCROSS, London (GB); Beau CHESLUK, London (GB); Anthony RUSHTON, West Byfleet (GB); Russell IRWIN, London (GB); Maximillian MURPHY, London (GB)

(73) Assignee: Telemetry Limited, London (GB)

(21) Appl. No.: 14/046,593

(22) Filed: Oct. 4, 2013

(30) Foreign Application Priority Data
Oct. 4, 2012 (GB) 1217796.0

(51) Int. Cl. G06Q 30/02

(52) U.S. Cl. CPC G06Q 30/0242
USPC 705/14.41

(57) ABSTRACT

A method of quantifying the effectiveness of delivery of digital media content comprises identifying a group of instances of delivery of digital media content, calculating a plurality of metrics for the group, each metric indicative of a different aspect of effective delivery of the digital media content, and combining the calculated metrics into a single indicator of the effectiveness of the delivery of digital media content for the group. The group of instances can represent the delivery of digital media content by a particular supplier or a particular service of a particular supplier of digital media distribution services over a period of time. The metrics can be indicative of the proportion of the instances that were visible or audible to a viewer of the digital media content.

### BACKGROUND

Online advertising on the World Wide Web is an increasingly important communication channel for businesses, on which significant marketing budgets are spent. In particular, digital video advertising is increasingly used. An advertiser or advertising agency will create an advertisement in the form of digital video content, which is then distributed by a publisher who delivers the digital video content to appropriate positions in web pages for viewing by the consumer. The digital video content may also be provided as “pre-roll” content to a digital video that the consumer has selected for viewing. Typically, the advertiser pays the publisher per instance of the digital video content delivered.

In order for the advertiser to be confident that they are receiving value for money it is desirable that the digital video content is provided to the viewer in a way that enables the viewer to absorb the marketing messages in the digital video content. For example, the digital video content should be visible on the viewer's screen, i.e. not hidden, should be audible to the viewer, i.e. not muted, and should be visible to the viewer for a period of time that is long enough for the viewer to watch the video content.

It is therefore desirable to be able to quantify the effectiveness of the delivery of digital media content across publishers and the services offered by publishers.

The embodiments described below are not limited to implementations which solve any or all of the disadvantages of known content consumption verification systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

The present invention, at least in its preferred configuration, seeks to provide a method of quantifying effectiveness of the delivery of digital media content in a reliable and easily comparable indicator.

The method comprises identifying a group of instances of delivery of digital media content, calculating a plurality of metrics for the said group, each metric indicative of a different aspect of effective delivery of the digital media content, and combining the calculated metrics into a single indicator of the effectiveness of the delivery of digital media content for the group.

Thus, in accordance with the invention, a single indicator provides a reliable indicator of the effective delivery of digital media content. The indicator may be provided as a numerical value, a grade (e.g. AAA, AA, AB, etc.) or otherwise.

The group of instances may represent the delivery of digital media content by a particular supplier of digital media distribution services over a period of time. Thus, the indicator may evaluate the performance of a particular supplier. Alternatively or in addition, the group of instances may represent the delivery of digital media content by a particular service of a particular supplier of digital media distribution services over a period of time. Thus, the indicator may evaluate the performance of a particular “product” of a particular supplier or suppliers.

At least one of the metrics is an indicator (“visible media”) of the proportion of the instances that were visible to a viewer of the digital media content. It is possible for digital media content to be delivered to the web browser of a user or viewer without the digital media content being visible on the user's screen. This metric provides an indication of the delivery instances that were visible.

At least one of the metrics may be an indicator (“audible media”) of the proportion of the instances that were audible to a viewer of the digital media content. It is possible for digital media content to be delivered to the web browser of a user or viewer without the digital media content being audible to the viewer, for example because the sound level has been muted by a player control. This metric provides an indication of the delivery instances that were potentially audible.

At least one of the metrics is an indicator (“dwell time”) of the amount of time the digital media content was accessed by a viewer in each instance. It is desirable for the viewer to access the digital media content for long enough to absorb the messages in the digital media content.

At least one of the metrics is an indicator (“geo target”) of the proportion of the instances that were delivered to a viewer in a predetermined geographical area. Advertising campaigns are often geographically focused and it is important to an advertiser that the digital media content was delivered to the target geographical area, e.g. the target country.

At least one of the metrics is an indicator (“multiple exposure”) of the proportion of the instances that were delivered to a viewer without a second instance of the same digital media content being delivered to the same viewer at substantially the same time. It is possible for distributors of digital media content to deliver multiple instances of the same content to the same user at the same time in order to maximize the total number of instances of delivery. However, there is no value to the advertiser in delivering the same digital media content to the viewer at the same time.

At least one of the metrics is an indicator (“stability”) of the consistency (low variability) over time of one or more of the other metrics. This indicator may be an indicator of the consistency over time of all of the other metrics.

In the presently preferred embodiment of the invention, the single indicator is a combination of visible media, audible media, dwell time, geo target, multiple exposure and stability.

The calculation and combination of the metrics may be carried out by means of any suitable mathematical formula.

The method may further comprise providing an indication (“reach”) of the number of viewers to whom digital media content has been delivered by the instances in the group. In the presently preferred configuration, reach is not a metric which contributes to the single indicator.

The method may further comprise providing an indication (“inventory”) of the number of different items of digital media content that have been delivered by the instances in the group. In the presently preferred configuration, inventory is not a metric which contributes to the single indicator.

The method may further comprise providing a comparison of the value of the indicator for different groups of instances. For example, a ranking table or index may be provided comparing the performance of different suppliers.

The method may further comprise sending at least one of the plurality of metrics for the group and the single indicator to a user interface.

Another aspect of the invention provides an indicator value calculated in accordance with the method. Another aspect of the invention provides a collection of such indicator values, such as a ranking table, for a plurality of groups. The invention further extends to data processing apparatus configured to carry out the method and to computer software which configures a general purpose computer to operate as such data processing apparatus. Another aspect provides one or more tangible device-readable media with device-executable instructions that, when executed by a computing system, direct the computing system to perform steps of the method.

In summary, a method of quantifying the effectiveness of the delivery of digital media content comprises identifying a group of instances of delivery of digital media content, calculating a plurality of metrics for the group, each metric indicative of a different aspect of effective delivery of the digital media content and combining the calculated metrics into a single indicator of the effectiveness of the delivery of digital media content for the group.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a system for delivering digital media content to a user terminal;

FIG. 2 shows an overview of calculation of metrics and a single indicator;

FIG. 3 shows communication between network entities;

FIG. 4 schematically shows an example of processing data received from a terminal for use in calculating a metric;

FIG. 5 schematically shows another example of processing data received from a terminal for use in calculating a metric;

FIG. 6 schematically shows another example of processing data received from a terminal for use in calculating a metric;

FIG. 7 schematically shows another example of processing data received from a terminal for use in calculating a metric;

FIG. 8 schematically shows another example of processing data received from a terminal for use in calculating a metric;

FIG. 9 shows calculation of metrics and of a combined indicator;

FIG. 10 shows calculation of a final indicator/score of effectiveness of the delivery of digital media content;

FIG. 11 shows a user interface for displaying metrics and a final indicator/score of the effectiveness of the delivery of digital media content;

FIG. 12 shows a computing-based device for implementing any of the described methods;

FIG. 13 shows a method of quantifying the effectiveness of delivery of digital media content.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

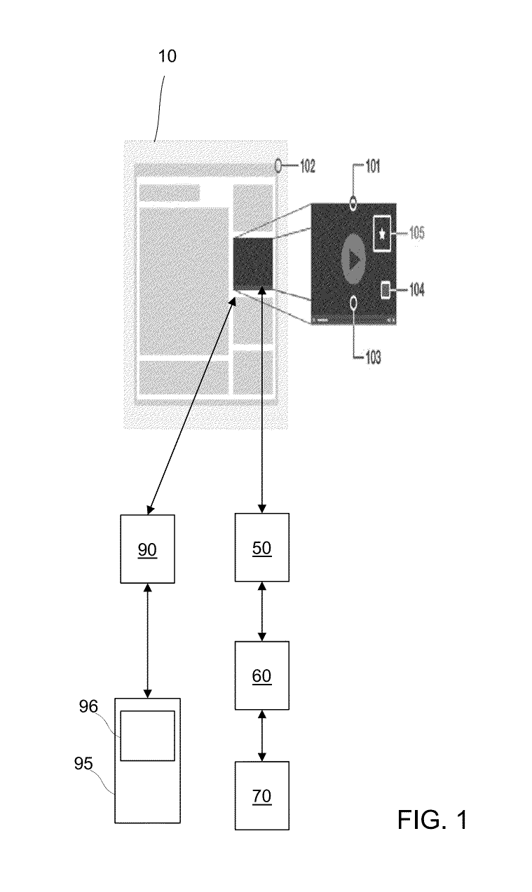

FIG. 1 illustrates a system overview of a network for distributing digital media content in a web-based environment. FIG. 1 shows a user terminal 10 which runs a web browser. The user terminal 10 may take the form of any electronic device which is capable of running a web browser or other interface through which digital media content may be obtained. The user terminal 10 may, for example, be a desktop computer or PC, or a portable or mobile device with a wired or wireless data connection. In some embodiments, the user terminal 10 may be a tablet computing device, a netbook, a laptop or a mobile phone capable of running the web browser. The web browser may, for example, comprise one of the following web browsers: Google Chrome™, Mozilla Firefox™, Internet Explorer™ or Safari™. This list is not intended to be exhaustive. In use, the web browser may be operated to access web pages. FIG. 1 shows an example browser window 102 displaying a web page. Some web pages may be designed with specific areas or frames of the page allocated for media to play. In some embodiments, the media may be in the form of a video. In some embodiments, the media may take the form or audio or rich media, such as an image. In some embodiments, the media may be interactive. A media placement 101 exists on the page 102 that may be statically or dynamically generated. The media placement can be loaded with an ad player that plays the digital media content 103. Signalling can occur between the user terminal 10 to a remote server 90 during playback of the digital media content for use in verifying one or more aspects of the media placement/playback. The signalling can use a plurality of tracking pixels 104 and can load tracking components such as a transponder 105. As described below, server 90 calculates a plurality of metrics for the group of instances of delivery of digital media content. Each metric is indicative of a different aspect of effective delivery of the digital media content. The calculated metrics can be combined into a single indicator of the effectiveness of the delivery of digital media content for the group. This provides information to quantify the effectiveness of the delivery of the digital media content.

The transponder 105 can be a component in the video player, and is typically software running in the video player. In some situations, the transponder may be loaded via a plug-in architecture at ad-display time. In some situations, the transponder may be a physical computer or co-computer. In some situations, the transponder may be broken up into two parts, one part hardware that is fixed, or otherwise “built in”, with the other part as a loadable module.

FIG. 1 also shows a user terminal 95 and a user interface 96. Any or all of the data calculated by server 90 can be communicated between the server 90 and terminal 95 and user interface 96. This can allow a party, such as the person responsible for placing the digital media content, to view the effectiveness of the placement.

In arrangements where the media takes the form of an advertisement, the advertisement may be distributed through a number of different servers before it is delivered to the web browser. The distribution of media and particularly video media such as advertisements can be considered a marketplace of selling and re-selling of media publications. In an exemplary arrangement, an advertiser will make an agreement with a first publisher to publish media in the form of an advertisement a fixed number of times. From this, the advertiser will distribute the media from an ad server 70 to the first publisher's server 60. The first publisher will seek to publish the advertisement to a number of user terminals, in order to fulfill the agreement. If the first publisher is unable fulfill the agreement, the first publisher may arrange the further distribution of the media with a second publisher in order to fulfill the original agreement, and the first publisher may distribute the media to the second publisher's server 50. This may then continue to a third publisher if the second publisher is unable to fulfill the original agreement, and so on. An ad server may be considered a server, such as a web server, that operates to store media such as advertisements. Such media may be delivered to user terminals when a user visits a particular web page or website. In addition, ad servers may also act to target particular media to particular users depending upon a set of rules. Therefore, a particular media, such as a particular advertisement, may have been placed on a plurality of different ad servers in order to form a chain between the original advertiser and the publisher's ad server 50 through any number of different ad servers before being published to a particular user terminal 10. Each advertisement receives media from a publisher when a web page is loaded.

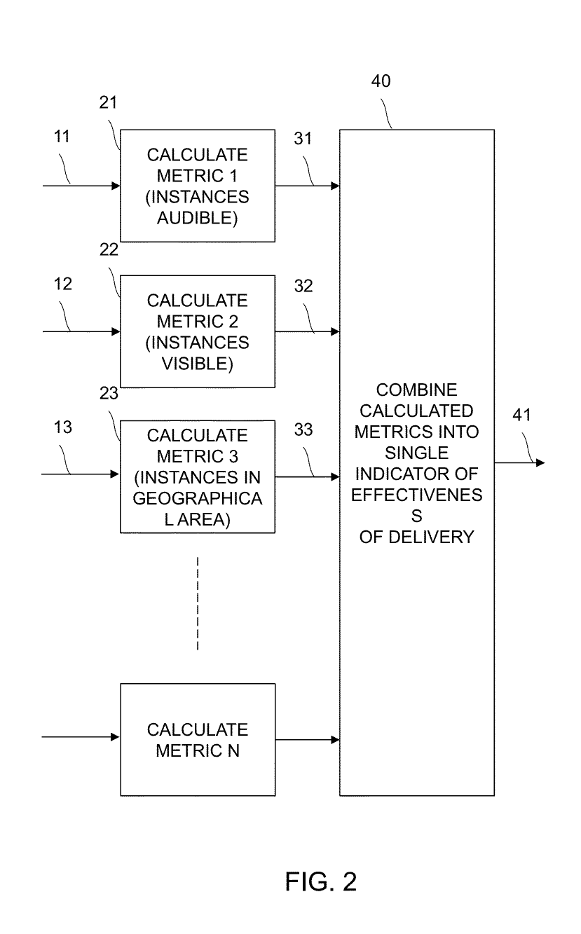

FIG. 2 shows an overview of calculating metrics and a single indicator of effectiveness of delivery. This can be performed at the server 90 of FIG. 1. FIG. 2 shows calculation of N different metrics. A first metric calculation module 21 receives data 11 which can be used to calculate the first metric, and outputs a first calculated metric 31. Similarly, a second metric calculation module 22 receives data 12 which can be used to calculate the second metric, and outputs a second calculated metric 32. This is repeated for a number N of different metrics. Each metric represents a different aspect of the delivery of the digital media content, such as: instances that were audible, instances that were visible. Some of the data 11, 12, 13 applied to the metric calculation modules 21, 22, 23 can be the same. Calculated metrics 31, 32, 33 are applied to a module 40 which combines the metrics into a single indicator 41 of effectiveness of delivery of media content.

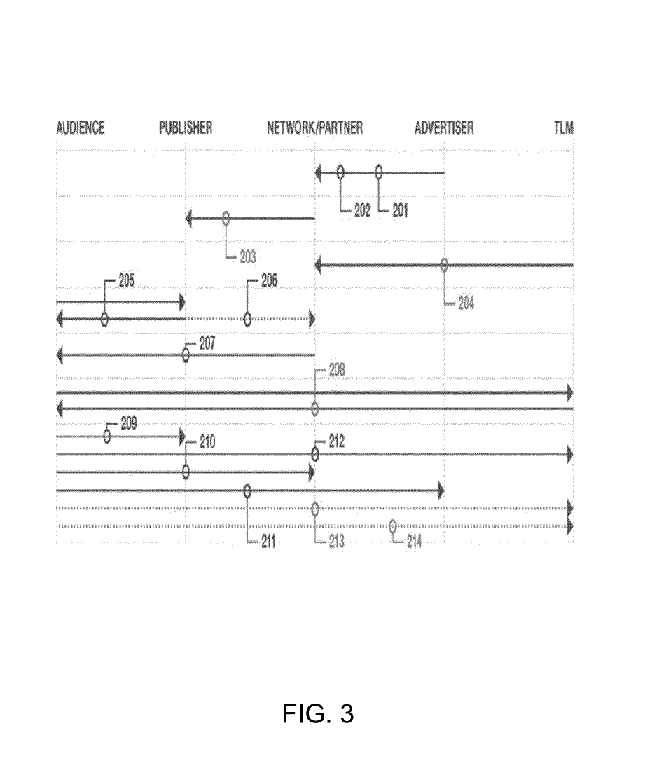

FIG. 3 shows an example of communication between network entities involved in the distribution of digital media (e.g. adverts). Before the audience visits the web page 102 containing the media placement, the advertiser will work with a network partner (or in some circumstances the publisher directly) and delivers to them a tracking pixel 201 and the digital media assets 202, while the network partner will have an existing relationship with the page publisher (or in some circumstances be the publisher) and deliver to them some integration device such as an ad tag or an embedded player 203. The network partner may also have a relationship with the monitoring entity (TLM) who will give the transponder and “trigger pixel” 204 to the network partner of the publisher.

When web pages are requested, the publisher sends a media player 205 to the audience. The publisher may load ad configuration from a network partner 206. The network partner (or in some circumstances, the publisher directly) will send the tracking pixel and digital media assets together 207 to the audience. Meanwhile, the embedded transponder will make a request to the server of the monitoring entity (TLM) and receive a session ID 208.

When the ad begins playback, several parties will be notified using a “tracking pixel” or a “trigger pixel”; a pixel may be fired that belongs to the publisher 209, and/or to the network partner 210, to the advertiser 211. That the monitoring entity (TLM) requires a trigger pixel is not unusual, and will be fired at the same time 212. Trigger pixels are represented later 302, 402, 502, 602, 702.

Meanwhile, while the component is loaded, it will begin sending back a pulse 213 to the monitoring entity. This pulse contains every signal generated by the component/transponder 105. Periodically, the component will send more pulse data 214. The cumulative pulse data is represented later 301, 401, 601.

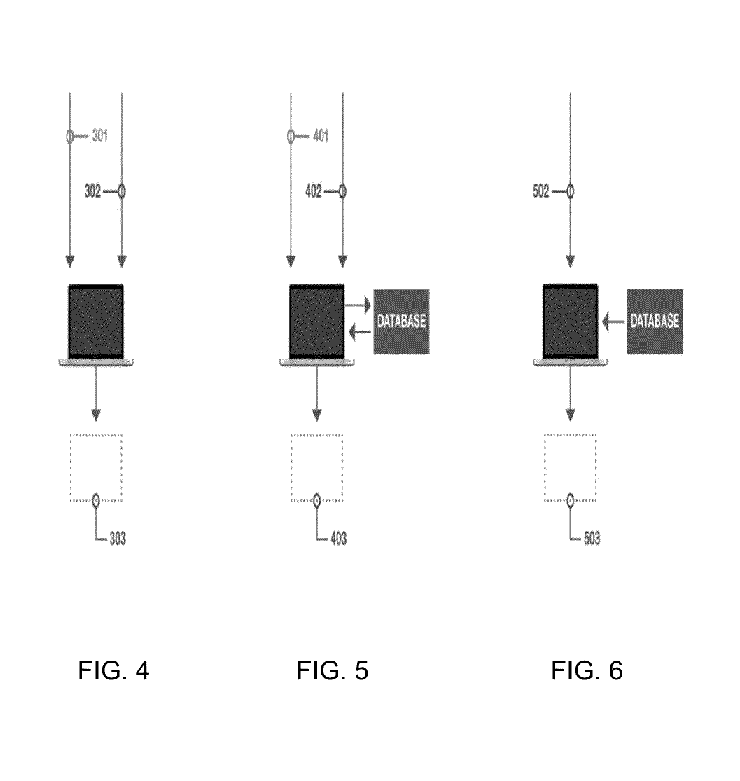

FIG. 4-FIG. 8 show some possible ways of processing data received from a terminal for use in calculating a metric. This processing can be performed at the server 90 of the monitoring entity. The data input to FIG. 4-FIG. 8 can use the signaling shown in FIG. 3. The signaling can be used to verify media placement/playback.

In FIG. 4, pulse data 301 sent from a user terminal is received and is accumulated. For example, the accumulation can occur in a memory cell reserved for a particular User Agent (UA)/Internet Protocol (IP) address combination, representing a single user. When a trigger pixel is received 302, the computer reads that memory cell and records the current value in the session-output 303. This can be used to implement the visible media metric and the audible media metric.

The “trigger pixel” is being trafficked by a different team from the pulse. Generally, in media buying, an advertiser and/or their agency will identify a specific buy (which may contain a number of different products, some of which chosen dynamically and in real-time) with a pixel. This pixel may be targeting a demographic, or psychographic that the advertiser is interested in, and so when the publisher sells some audience to an advertiser, this is how the buy is identified. In contrast, the pulse is embedded in the player, which as can be seen in FIG. 2, may be delivered, owned and operated by a different party, such as the publisher partner. It will be appreciated that although two communication channels are described in this embodiment, other alternative configurations or means may be used; for example, it may be possible to identify the advertisement by its size and/or by the flashvars.

In FIG. 5, pulse data (401) is received at the server 90. Pulse data can include a session id. The different session ids are recorded in the database. The trigger pixel 402 contains the product and vendor and is stored in the database, extracting session ids from the database. The number of session ids recorded for a given vendor indicates a number of times a particular user has been exposed to the same content. This can provide the multiple-exposure sensor/metric.

In FIG. 6 there is no pulse data. The trigger pixel 502 signals the computer to load some results from a database. This computer can be used to implement the “geo-targeted” metric, since the IP address from the trigger pixel can be matched against the database. The result of the sense is stored in the session-output 503.

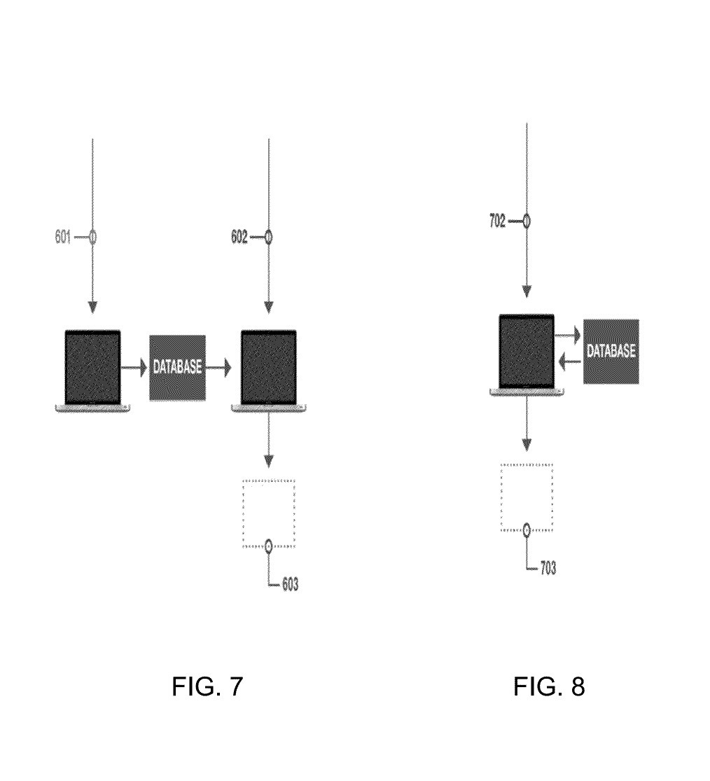

In FIG. 7, the pulse 601 enters one computer and information is stored in a database. When the trigger pixel 602 enters another computer, it consults the database. If there are enough pulses in the database, the computer can calculate how long the audience was on the page, and this computer can implement the dwell-time metric. The computer can also be configured to store the session ID in the database, and in this configuration the computer handling the trigger pixels can calculate a count of sessions.

In FIG. 8 no pulse data is needed. The trigger pixel 702 is looked up in the database. If the UA/IP combination is present, the computer can calculate unique audience.

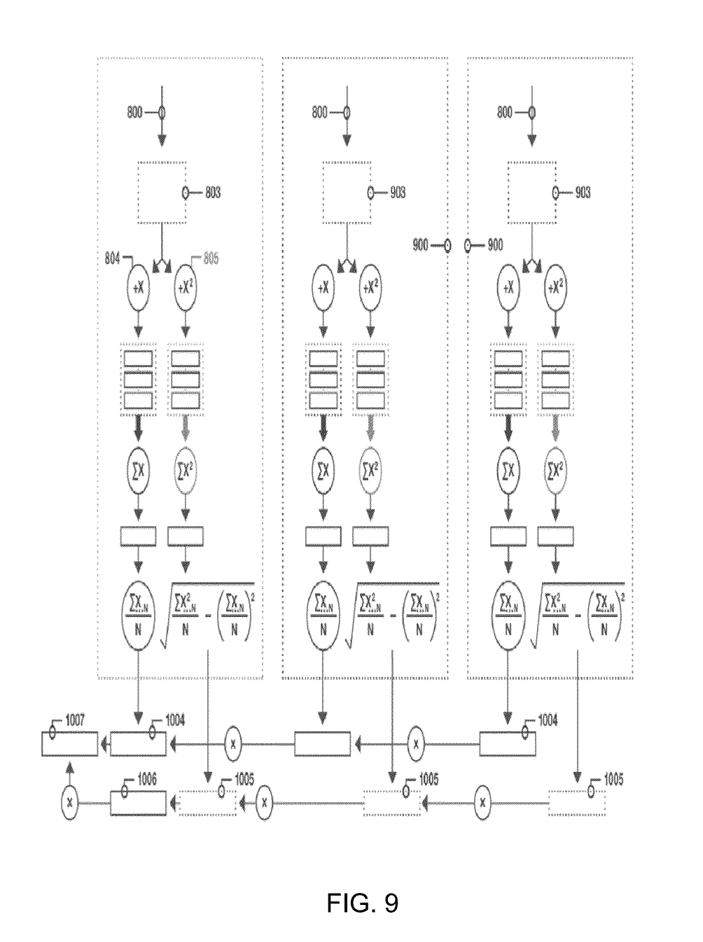

FIG. 9 shows calculation of metrics. A single calculation pipeline, or multiple calculation pipelines, can be used to calculate the metrics. Where multiple pipelines are used, each pipeline can calculate a single metric using one of the computers shown in FIG. 4-FIG. 8, and accumulate the output-cell over several events.

Data coming from one of the computers shown in FIG. 4-FIG. 8 is recorded in an output cell 803. The sum of the output cells 804 is accumulated into one storage address for the metric, while the sum of the squares of the output cells 805 is accumulated in another storage address. The sum is used to determine an average (mean) value of the metric. The sum of squares is used to determine a variation (standard deviation) in the value of the metric.

The storage addresses for other metrics 903 feed into other calculation pipelines 900.

A mean is determined for each metric. This can be accumulated in a memory cell 1004. A standard deviation is determined for each metric. This can be accumulated in a separate memory cell 1005. The stability metric can be determined from the standard deviation, such as by multiplying the standard deviation. The stability metric can be stored in a cell 1006.

All of the metrics are combined to produce the final score 1007. The combining can, for example, use a combination of multiplication and some weighting coefficients.

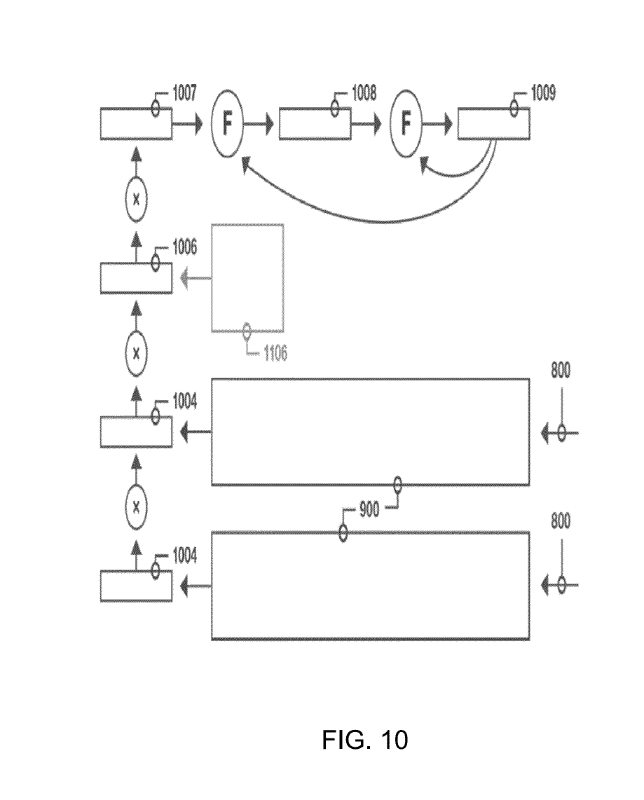

FIG. 10 shows additional, optional, processing of the final score 1007. Final scores from the calculation machine 1007 can be applied to a function against the CPM and industry knowledge 1008, to produce a rating value 1009. CPM is an industry standard term for the price of the media and means “cost per mille” or “cost per thousand”. For example, the advertiser can buy 1000 ad requests for a given CPM. These values are fed back into the two functions using some combinator, in at least one embodiment using linear regression. The “industry knowledge” could be anything a human being collects and identifies as relevant, inserting a fixing coefficient into the system.

Function “F” can be any device that fits with subjective sense. For example, Multiple Exposure is something that is very easy for publishers to avoid, so a function that goes to zero when the multiple exposure goes above a few percent can be used here. These could be any mathematical functions, with the data fitted to the function.

The calculation pipelines 900 feed into their metric outputs 1004 and the stability-calculator 1106 to produce the stability score 1006.

Note again the placement of data coming in 800, and that 900 represent the entire calculation device. There is a duplication, hence there is more than one 1004 and more than one 900. These are duplicated for each metric. Node 1106 comes from historical data (e.g. last 7 days). Note the arrows from the final score 1009 “feeds back” into the stability coefficient and the scoring combinator. This is done in order to make the final scores more competitive (i.e. more actionable by the media buyer). The arrows are not process-arrows but the data moves simultaneously throughout the system in a state of hysteresis.

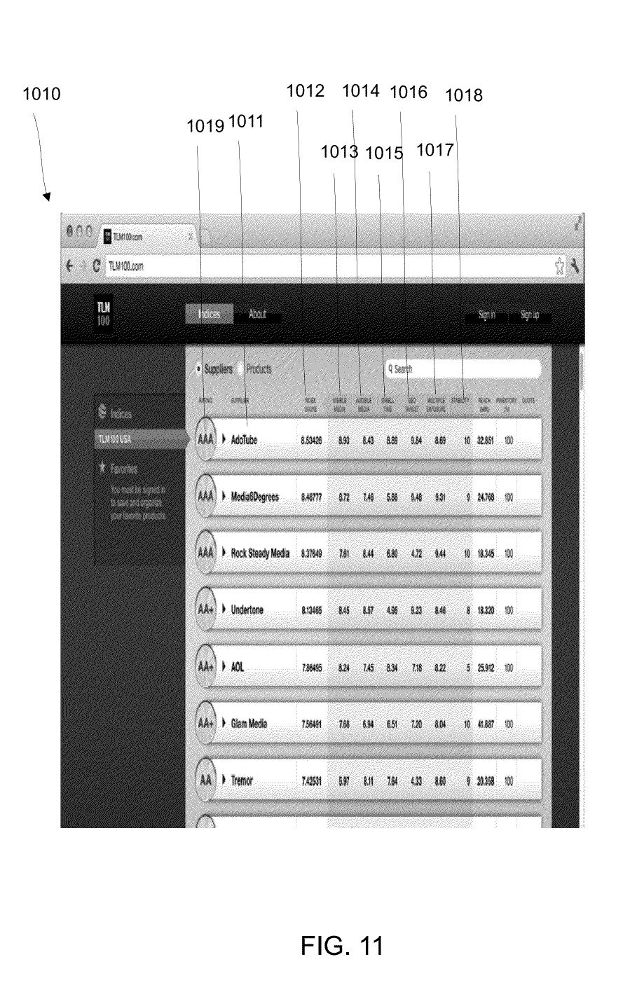

FIG. 11 shows an example of a ranking of suppliers of digital media distribution services on the basis of a single indicator value calculated in accordance with an embodiment. FIG. 11 shows an example of a window 1200 of a user interface reporting metric values for different suppliers. Window 1200 can form part of the user interface 96 shown in FIG. 1. The “supplier” can be an advertising publisher shown in FIG. 1 and FIG. 3. In this example, suppliers are arranged as a ranking table, according to order of the single overall numerical metric value 1012 and/or grade 1019 which can be calculated as described above. The single indicator provides a reliable indicator of the effective delivery of the digital media content. The indicator may be provided as a numerical value, a grade (e.g. AAA, AA+, AA, etc.) or otherwise.

FIG. 11 shows additional metrics and parameters per supplier. At least one of the metrics is an indicator (“visible media”) of the proportion of the instances that were visible to a viewer of the digital media content. It is possible for digital media content to be delivered to the web browser of a user or viewer without the digital media content being visible on the user's screen. This metric provides an indication of the delivery instances that were visible.

At least one of the metrics may be an indicator (“audible media”) of the proportion of the instances that were audible to a viewer of the digital media content. It is possible for digital media content to be delivered to the web browser of a user or viewer without the digital media content being audible to the viewer, for example because the sound level has been muted by a player control. This metric provides an indication of the delivery instances that were potentially audible.

At least one of the metrics is an indicator (“dwell time”) of the amount of time the digital media content was accessed by a viewer in each instance. It is desirable for the viewer to access the digital media content for long enough to absorb the messages in the digital media content.

At least one of the metrics is an indicator (“geo target”) of the proportion of the instances that were delivered to a viewer in a predetermined geographical area. Advertising campaigns are often geographically focused and it is important to an advertiser that the digital media content was delivered to the target geographical area, e.g. the target country.

At least one of the metrics is an indicator (“multiple exposure”) of the proportion of the instances that were delivered to a viewer without a second instance of the same digital media content being delivered to the same viewer at substantially the same time. It is possible for distributors of digital media content to deliver multiple instances of the same content to the same user at the same time in order to maximize the total number of instances of delivery. However, there is no value to the advertiser in delivering the same digital media content to the viewer at the same time.

At least one of the metrics is an indicator (“stability”) of the consistency (low variability) over time of one or more of the other metrics. This indicator may be an indicator of the consistency over time of all of the other metrics.

The single indicator 1012 is a set of 1007, and the indicator 1019 is a set of 1009. The single indicator 1012 and/or indicator 1019 may be a combination of visible media, audible media, dwell time, geo target, multiple exposure and stability. The user interface can allow a user to customize the interface in various ways, such as to allow the user to select which metrics (columns) are displayed. As shown in FIG. 1, the user interface can be displayed on a user device remote from where the calculation of the metrics occurs.

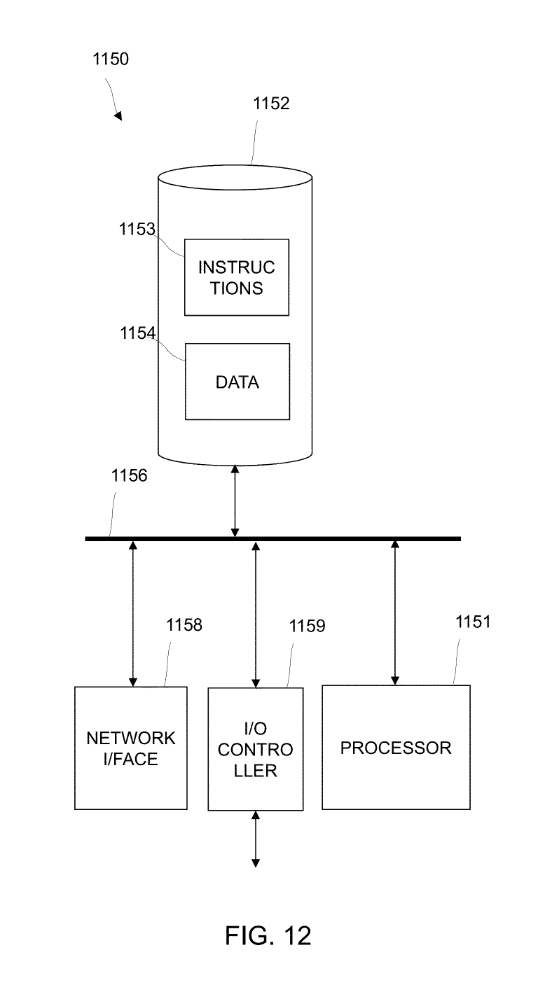

FIG. 12 shows an example of a computing based device 1150. This can be used to implement the server 90 or perform the calculation of metrics, or combination of metrics, shown in previous Figures.

Computing-based device 1150 comprises one or more processors 1151 which may be microprocessors, controllers or any other suitable type of processors for processing computer executable instructions to control the operation of the device. In some examples, for example where a system on a chip architecture is used, the processors 1151 may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Computer executable instructions 1153 may be provided using any computer-readable media that is accessible by computing based device 1150. Computer-readable media may include, for example, computer storage media such as memory 1152. Computer storage media, such as memory 1152, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 1202) is shown within the computing-based device 1150 it will be appreciated that the storage may be distributed or located remotely and accessed via a network or other communication link (e.g. using communication interface 1158).

The computing-based device 1150 also comprises an input/output controller 1159 arranged to output display information to a display device which may be separate from or integral to the computing-based device 1150. The display information may provide a graphical user interface. The input/output controller 1159 is also arranged to receive and process input from one or more devices, such as a user input device (e.g. a mouse or a keyboard). This user input may be used to control whether the device is in an offline or online state, to consume content, to control generation of proof of work tokens or for other purposes. In an embodiment the display device may also act as the user input device if it is a touch sensitive display device. The input/output controller 1159 may also output data to devices other than the display device, e.g. a locally connected printing device. One or more buses 1156 connect the components of the computing-based device.

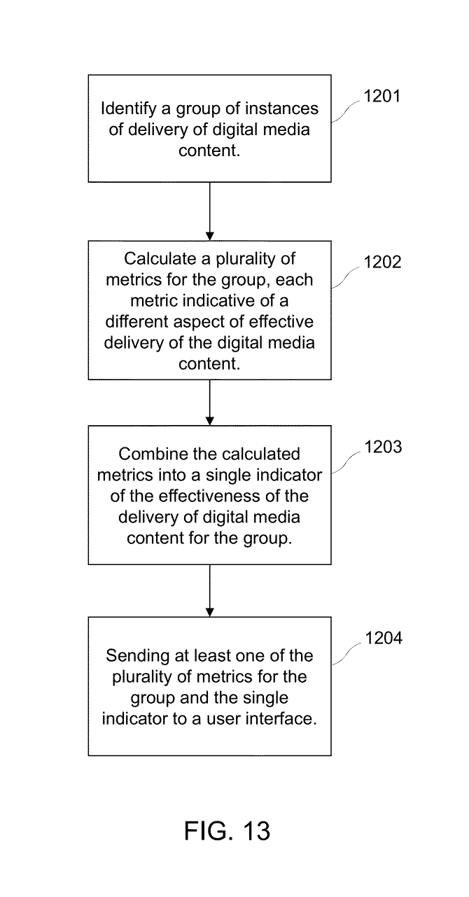

FIG. 13 shows a method of quantifying the effectiveness of delivery of digital media content. The method comprises a step 1201 of identifying a group of instances of delivery of digital media content. The method comprises a step 1202 of calculating a plurality of metrics for the group, each metric indicative of a different aspect of effective delivery of the digital media content. The method comprises a step 1203 of combining the calculated metrics into a single indicator of the effectiveness of the delivery of digital media content for the group. Optionally, the method can comprise a step 1204 of sending at least one of the plurality of metrics for the group and the single indicator to a user interface.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of quantifying the effectiveness of delivery of digital media content, the method comprising:
identifying a group of instances of delivery of digital media content;
calculating a plurality of metrics for the group, each metric indicative of a different aspect of effective delivery of the digital media content; and
combining the calculated plurality of metrics into a single indicator of the effectiveness of the delivery of digital media content for the group.

2. The method of claim 1, wherein the group of instances represents the delivery of digital media content by a particular supplier of digital media distribution services over a period of time.

3. The method of claim 2, wherein the group of instances represents the delivery of digital media content by a particular service of a particular supplier of digital media distribution services over a period of time.

4. The method of claim 1, wherein at least one of the plurality of metrics is an indicator of a proportion of the group of instances visible to a viewer of the digital media content.

5. The method of claim 1, wherein at least one of the plurality of metrics is an indicator of a proportion of the group of instances that is audible to a viewer of the digital media content.

6. The method of claim 1, wherein at least one of the plurality of metrics is an indicator of an amount of time the digital media content is accessed by a viewer in each instance.

7. The method of claim 1, wherein at least one of the plurality of metrics is an indicator of a proportion of the group of instances that is delivered to a viewer in a predetermined geographical area.

8. The method of claim 1, wherein at least one of the plurality of metrics is an indicator of a proportion of the group of instances that is delivered to a viewer without a second instance of a same digital media content being delivered to a same viewer at substantially a same time.

9. The method of claim 1, wherein at least one of the plurality of metrics is an indicator of a consistency over time of one or more of the other metrics.

10. The method of claim 1, further comprising providing an indication of a number of viewers to whom digital media content is delivered by the group of instances.

11. The method of claim 1, further comprising providing an indication of a number of different items of digital media content that is been delivered by the group of instances.

12. The method of claim 1, further comprising providing a comparison of a value of an indicator for different groups of instances.

13. A method of calculating an indicator value, the method comprising:
identifying a group of instances of delivery of digital media content;
calculating a plurality of metrics for the group, each metric indicative of a different aspect of effective delivery of the digital media content; and
combining the calculated plurality of metrics into a single indicator of the effectiveness of the delivery of digital media content for the group.

14. The method of claim 13, wherein a plurality of indicator values is calculated for a plurality of groups of instances of delivery of digital media content.

15. An apparatus for data processing, the apparatus comprising:
a memory; and
at least one processor coupled to the memory and configured to:
identify a group of instances of delivery of digital media content;
calculate a plurality of metrics for the group, each metric indicative of a different aspect of effective delivery of the digital media content; and
combine the calculated plurality of metrics into a single indicator of the effectiveness of the delivery of digital media content for the group.

16. A computer program product, comprising:
a computer-readable medium comprising code for:
identifying a group of instances of delivery of digital media content;
calculating a plurality of metrics for the group, each metric indicative of a different aspect of effective delivery of the digital media content; and
combining the calculated plurality of metrics into a single indicator of the effectiveness of the delivery of digital media content for the group.
